(19) United States
(12) Patent Application Publication
(10) Pub. No.: US 2004/0007119 A1
(43) Pub. Date: Jan. 15, 2004

(54) Sound recording/playing jewelry case

(76) Inventor: Hyun Soo Ra, Yongin-City (KR)

Correspondence Address: NIXON & VANDERHYE, PC, 1100 N GLEBE ROAD, 8TH FLOOR, ARLINGTON, VA, 22201-4714, US

(21) Appl. No.: 10/404,126

(22) Filed: Apr. 2, 2003

(30) Foreign Application Priority Data
Jul. 11, 2002 (KR) 20-2002-0020852

(51) Int. Cl. G10H 1/00

(52) U.S. Cl. 84/600

(57) ABSTRACT

As it was stated earlier, the present invention has special feature of financial benefit and convenience since the sound the user recorded is played whenever the case is opened.

### BACKGROUND OF THE INVENTION

1. Field of the Invention

The present invention refers to sound recording/playing jewelry case which the user can record optional sound (voice mail with full of love etc.) and play it when it is opened.

Former jewelry cases did not have such recording/playing functions.

2. Description of the Prior Art

Generally, Traditional jewelry case was used for only keeping the jewelry and only played repeated sound saved in ROM of melody IC. The traditional jewelry case only played same sound regardless of users request for example, the jewelry case with carol song saved only played carol song the whole season.

### SUMMARY OF THE INVENTION

The present invention refers to jewel case not only to keep the jewelry or other accessories but also to record music or voice message so that when the case is opened the music or the voice message recorded will play.

Therefore the special feature of the present invention is that voice of the used with back ground sound can be recorded bad played by sensor to perceive light when the case is opened.

For this function, a space inside frame while out side feature is maintained and covering part covering inner frame where a side is opened to keep jewelry and other accessories and inner frame are added to open and close the contactor repeatedly. Microphone, sensor (on/off sensor, reverse sensor etc.), recording jack socket, volume switch, recording/playing option switch and speaker compose a IC which with light sensor to maintains the function of this invention.

### BRIEF DESCRIPTION OF THE DRAWINGS

The aforementioned aspects and other features of the present invention will be explained in the following description, taken in conjunction with the accompanying drawings, wherein:

FIG. 1 Sectional Diagram of the Invention

FIG. 2 Compositional Diagram of Circuit in this Invention

FIG. 3 Another Compositional Diagram of Circuit in this Invention

### EXPLANATION OF SYMBOLS IN EACH FIGURE

| | |
|---|---|
| 1.Jewelry Case | 2.Jewelry Case Floor |
| 3.Inner Frame Part of Jewelry Case | 4.Recorder/Player Switch |
| 5.Recordable Jack Socket | 6.Microphone |
| 7.Speaker | 8.Recorder/Player IC |
| 9.Sensor | 10.Circuit System |
| 11.Battery | 12.IC for Recording Player |
| 13.TR | 14.Hole |
| 15.Volume | 16.Mirror |

### DETAILED DESCRIPTION OF PREFERRED EMBODIMENTS

The present invention refers to sound recording/playing jewelry case which the user can record optional sound (voice mail with full of love etc.) and play it when it is opened.

Former jewelry cases did not have such recording/playing functions.

Traditional jewelry case was used for only keeping the jewelry and only played repeated sound saved in ROM of melody IC. The traditional jewelry case only played same sound regardless of users request for example, the jewelry case with carol song saved only played carol song the whole season.

Technical Objective of the Invention

Therefore, to overcome the defect on the traditional jewelry case, the present invention has certain characteristic to save voice message full of love and play it whenever the jewelry case opens.

Structure and Function of the Invention

Following are the structure and function of invention explained in detail by operational examples.

### EXAMPLE 1

This example shows the case when recording/playing IC is composed to circuit figure.

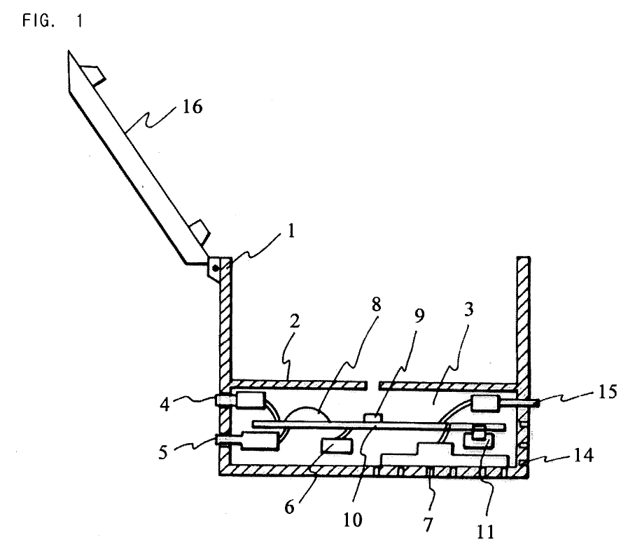

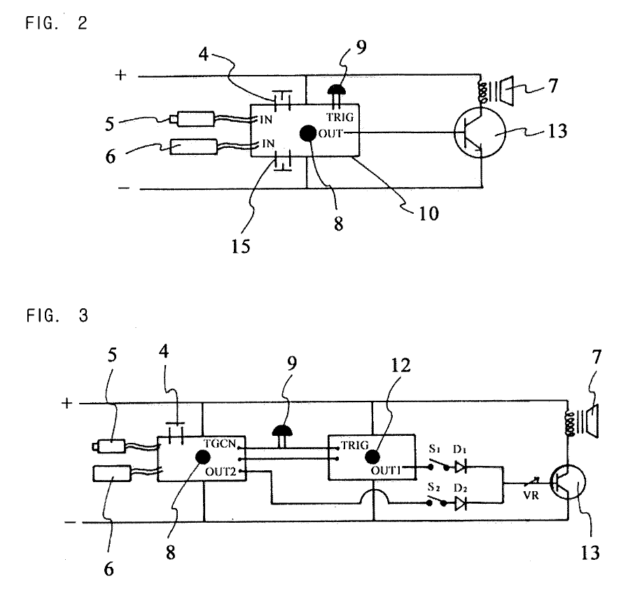

This example is made of FIG. 1 and FIG. 2. The voice and sound recording/playing circuit (10) and a sensor (9) are placed in space (3) under floor (2) of the jewelry case so that when case is opened light from out side can enter the circuit system. Microphone (6), recording jack socket (5), recording/playing option switch (4), volume switch (15) and sensor (9) are connected to IC (8) which recording and playing is available in circuit system (10) and also speaker (7) on both side of power switch, amplifying TR (13) are connected in series format and top part of base of the amplifying TR (13) is connected to output source of IC (8) to organize circuit. And also, by making several holes (14) on space of inner floor frame (3) where circuit system is place (10) circulation of microphone (6) and speaker (7) built inside are available.

And also by placing recording/playing option switch (4) and recording jack socket (5) penetrating a side of inner floor frame (3), control can be available from out side of floor frame (3).

Recording/playing technique and circuit composition of recording/playing IC (8) in this example are already put out ahead.

And also, it is quite sure that the technique operating circuit system by letting sensor (9) to perceive light by letting the light enter the inner floor frame (3) whenever the case is opened is also put out earlier as seen in FIG. 1.

It is assured that any traditional technique used to perceive light can be used in the present invention and it is also sure that any recording/playing technique for circuit composition can be used too.

By adding circuit technique and circuit operational technique by perceiving function of sound recording/playing jewelry case already put out to compose recording/playing jewelry case is this inventions intend.

The operational effect of this example is stated as followed. When the user press recording switch as seen in FIG. 2, recording/playing IC (8) turns to recording mode. Pressing the option switch, the recording switch, the voice or sound is recorded in recording/playing IC (8) through microphone (6) inside. To record sound from audio, connection jack can be used to connect to jack socket (5) of the case.

The technique saving sound to semiconductor device in digital data and playing it in analogue sound is already known earlier.

Once recording was done, sensor (9) of circuit (10) in inner floor frame perceives light and trigger the circuit (10) play sound when the case is opened.

Repetition of the sound played depends on whether IC function is level hold function or one short function. Usually both functions are inserted in option switch for user to choose.

The invention operated as stated above can record music, anniversary music, birthday song, love message, message about quit smoking, Christmas song and etc which is very convenient and financially beneficial.

Above mentioned are the functions of playing a sound only record.

### EXAMPLE 2

This example shows the use of IC for playing recorded sound along with melody or sound IC.

In this example message can be recorded and played along with the music played in IC when the jewelry case is opened and circuit composition as followed.

As shown in FIG. 3, recording/playing IC (8) and usual playing IC (12) and each IC trigger are connected in parallel and a sensor (9) is connected to this. And also amplifying TR (13) is connected to speaker (7) in series to connect to both side of power switch and on base of the TR (13), recording/playing IC (8) out put device and playing IC (12) out put device are connected but playing IC (12) must be connected through switch S1 and Diod D1. And out put device of IC (8) must be connected to base of above mentioned TR (13) through switch S2 and Diod D2 and also microphone (6), recording jack socket (5) and recording/playing option switch are connected to recording/playing IC (8).

Rest of compositional factor, placement of sensor (9) and inner floor flame (3) space of jewelry case (1) are the same as in example 1.

The operational effect of this example is stated as followed.

In FIG. 3, by user pressing recording/playing option switch turning the recording/playing IC (8) to recording mode, the sound the user wants is recorded through microphone (6). And then after recording the sound, by pressing OFF of recording/playing option switch (4) recording/playing IC (8) turns to playing mode.

In this playing mode, when the jewelry case (1) is opened, the light is perceived by the sensor (9) placed in inner floor frame and triggers both recording/playing IC (8) and playing (8) at the same time.

At this point, if the user turn switch 1 and 2 to ON mode, both recording/playing IC (8) and playing IC (12) will send out put signal to base of TR (13) through Diod D1 and D2 so that the sound of both two IC amplified by TR (13) is played by the above mentioned speaker (7).

The special feature in this case is that the sound user recorded is played along with the sound (music etc.) from playing IC (12).

If switch s2 is OFF while switch s1 is ON, sound from playing IC (12) is repeatedly played while the recorded sound isn't.

The special feature in this case is that this function is efficient when the person wants hear the recorded sound only him/herself since password system for input device can be applied to switch s2. This also can be applied to switch s1.

In FIG. 3, two ICs were composed together however these ICs can be produced in one chip format.

And also, in organizing this invention, recording jack can be used when jack is connected to (not shown in figure) recording jack socket (5), the above mentioned recording/playing IC (8) automatically turns to recording mode.

And also, it is certain that in regard to composing this example, one of above mentioned sensors (9) is connected to IC and another sensor not connected to another IC can be triggered with out put signal from the connected IC.

And also, to compose the system which control of the sound is available, variable resistor (VR) can be connected to base of TR (13) along with Diod D1 and D2 in series format or can be connected to speaker (7) and TR (13) in series format.

Above mentioned facts shows the efficiency and convenience of jewelry case which the sound of the user is played whenever the case is opened.

What is claimed is:

1. As the first sound playing jewelry case with composition of sensor in inner floor frame perceiving light and triggering circuit system:
Sound playing jewelry case with special composition of which the sensor (9), microphone (6), recording jack socket (5), recording/playing option switch (4) and volume control switch are connected to recording/playing IC (8) which the user can record and play the sound in circuit system (10) and base of TR (13) which speaker (7) is connected in series format is connected to output device of recording/playing IC (8) so whenever the case is opened above mentioned sensor (on/off sensor/heat sensor) to play recorded sound of the user.

2. As the first sound playing jewelry case with composition of triggering the sound playing circuit by perceiving the heat with connected sensor in inner floor frame, circuit system placed in space of inner floor frame (3) of the case, need to be composed of playing IC (12) and recording playing IC (8) which microphone and recording jack socket (5) is connected however out put device of recording/playing IC (8) will be connected to base of TR (13) through switch s2 and Diod D2 and also out put device of playing IC (12) need to be connected to base of TR (13) through switch 1 and Diod D1. And also, variable resistor (VR) need to be connected to in between base of TR and Diod D1 and D2 in series format and above mentioned TR need to be connected with speaker (7) in series format and power switch need to connected and also sensor (9) need to be connected to both trigger of recording/playing IC (8) and playing IC (12) so that whenever the case is opened, the sound the user recorded along with background sound is played while with switch control of two sounds by user option can be managed.

3. Jewelry case with recording function which has special feature of composition by controlling (not shown on figure) switch s1 and s2 in claim 2.

4. Jewelry case with recording function which has special feature of rebuilding circuit system to one chip which both recording/playing IC function and playing IC function are put together.
